(19) United States
(12) Patent Application Publication
(10) Pub. No.: US 2025/0113397 A1
(43) Pub. Date: Apr. 3, 2025

(54) METHOD FOR TRANSMITTING AND RECEIVING DATA IN SHORT-RANGE WIRELESS COMMUNICATION SYSTEM, AND DEVICE THEREFOR

(71) Applicant: LG ELECTRONICS INC., Seoul (KR)

(72) Inventors: Hyeonjae LEE, Seoul (KR); Jongmin KIM, Seoul (KR)

(73) Assignee: LG ELECTRONICS INC., Seoul (KR)

(21) Appl. No.: 18/727,864

(22) PCT Filed: Jan. 10, 2023
(86) PCT No.: PCT/KR2023/000451

§ 371 Date: Jul. 10, 2024

(30) Foreign Application Priority Data
Jan. 10, 2022 (KR) 10-2022-0003534

(51) Int. Cl. H04W 76/14; H04W 4/80

(52) U.S. Cl. CPC H04W 76/14; H04W 4/80

(57) ABSTRACT

Provided are a method for transmitting and receiving data in a short-range wireless communication system, and a device therefor. More specifically, the method comprises the steps of: forming an isochronous channel with a second device for transmitting the data; and transmitting the data to the second device over the isochronous channel, wherein the data is human interface device (HID) data, the data is human interface device (HID) data, and the channel for transmitting the data is determined on the basis of data characteristics including reliability and urgency.

### TECHNICAL FIELD

The present disclosure relates to a method for transmitting and receiving data using a short-range communication technology in a wireless communication system and a device therefor, and more particularly to a method and device for transmitting and receiving data using Bluetooth technology.

### BACKGROUND ART

Bluetooth is a short-range wireless technology standard that may wirelessly connect various types of devices and allows them to exchange data over short distances. To enable wireless communication between two devices using Bluetooth communication, a user has to perform the process of discovering Bluetooth devices to communicate with and making a connection request. As used herein, the term “device” refers to an appliance or equipment.

In this case, the user may discover a Bluetooth device according to a Bluetooth communication method intended to be used with the Bluetooth device using the Bluetooth device, and then perform a connection with the Bluetooth device.

Examples of the Bluetooth communication method include a Bluetooth basic rate/enhanced data rate (BR/EDR) method and a Bluetooth low energy (LE) method which is a low power method. The Bluetooth BR/EDR method may be referred to as classic Bluetooth. The classic Bluetooth method includes Bluetooth technology that has been continued from Bluetooth 1.0 using a basic rate to Bluetooth 2.1 and Bluetooth technology using an enhanced data rate supported since Bluetooth 2.0.

The Bluetooth low energy (hereinafter, referred to as ‘Bluetooth LE’) technology can stably provide information of hundreds of kilobytes by consuming low energy. The Bluetooth LE technology exchanges information between devices by utilizing an attribute protocol. This Bluetooth LE method can reduce energy consumption by reducing overhead of a header and simplifying an operation.

Some of the Bluetooth devices do not have a display or a user interface. The complexity of a connection, management, control, and a disconnection between various Bluetooth devices and Bluetooth devices using similar technologies is increasing.

Further, Bluetooth can achieve a relatively high speed at relatively low energy and low cost, but a transmission distance is limited to a maximum of 100 m. Therefore, Bluetooth is suitable for use in a limited space.

### DISCLOSURE

### Technical Problem

An object of the present disclosure is to provide a method of transmitting and receiving data in a short-range wireless communication system and a device therefor.

Another object of the present disclosure is to provide a method of transmitting and receiving data using an isochronous channel and a device therefor.

Another object of the present disclosure is to provide a configuration method for data retransmission when transmitting and receiving data using an isochronous channel and a device therefor.

Technical objects to be achieved by the present disclosure are not limited to the aforementioned technical objects, and other technical objects not described above may be evidently understood by a person having ordinary skill in the art to which the present disclosure pertains from the following description.

### Technical Solution

The present disclosure provides a method of transmitting and receiving data in a short-range wireless communication system and a device therefor.

More specifically, the present disclosure provides a method of transmitting, by a first device, data in a short-range wireless communication system, the method comprising forming an isochronous channel for transmitting the data with a second device; and transmitting the data to the second device on the isochronous channel, wherein the data is human interface device (HID) data, and the channel for transmitting the data is determined based on data characteristics including a reliability and an urgency.

The method may further comprise forming an asynchronous connection-less (ACL) channel for transmitting the data with the second device.

The method may further comprise, based on the data being a type of data where the reliability is prioritized regardless of the urgency, transmitting the data to the second device on the ACL channel.

Based on the data being a type of data where the urgency is prioritized, the data may be transmitted on the isochronous channel.

The method may further comprise retransmitting the data, and a number of times the data is retransmitted may be set to a specific number or less.

A time interval in which the data is retransmitted may be set based on a channel configuration parameter for configuring the isochronous channel. The channel configuration parameter may include a burst number (BN) representing a number of data packets within an isochronous interval that is a period in which the data transmission is performed, and a number of sub-events (NSE) representing a number of sub-intervals within the isochronous interval.

The retransmission of the data may be performed based on a method in which a value of the NSE is set to a multiple of a value of the BN.

The retransmission of the data may be performed as many times as the value of the NSE divided by the value of the BN.

Based on an initial transmission of the data being successful, a retransmission in a sub-interval in which the data is retransmitted may not be performed.

The retransmission of the data may be performed based on a method in which a value of the NSE and a value of the BN are set to the same value. The retransmission of the data may be performed regardless of whether an initial transmission of the data is successful or not.

The present disclosure also provides a first device transmitting and receiving data in a short-range wireless communication system, the first device comprising a transmitter configured to transmit a radio signal; a receiver configured to receive the radio signal; at least one processor; and at least one computer memory operably connectable to the at least one processor, wherein the at least one computer memory is configured to store instructions performing operations based on being executed by the at least one processor, wherein the operations comprise forming an isochronous channel for transmitting the data with a second device; and transmitting the data to the second device on the isochronous channel, wherein the data is human interface device (HID) data, and the channel for transmitting the data is determined based on data characteristics including a reliability and an urgency.

The present disclosure also provides a method of receiving, by a second device, data in a short-range wireless communication system, the method comprising forming an isochronous channel for transmitting the data with a first device; and receiving the data from the first device on the isochronous channel, wherein the data is human interface device (HID) data, and the channel for transmitting the data is determined based on data characteristics including a reliability and an urgency.

The present disclosure also provides a second device transmitting and receiving data in a short-range wireless communication system, the second device comprising a transmitter configured to transmit a radio signal; a receiver configured to receive the radio signal; at least one processor; and at least one computer memory operably connectable to the at least one processor, wherein the at least one computer memory is configured to store instructions performing operations based on being executed by the at least one processor, wherein the operations comprise forming an isochronous channel for transmitting the data with a first device; and receiving the data from the first device on the isochronous channel, wherein the data is human interface device (HID) data, and the channel for transmitting the data is determined based on data characteristics including a reliability and an urgency.

### Advantageous Effects

The present disclosure has an effect of transmitting and receiving data in a short-range wireless communication system.

The present disclosure also has an effect of transmitting and receiving data using an isochronous channel.

The present disclosure also has an effect of supporting a configuration for data retransmission when transmitting and receiving data using an isochronous channel.

The technical effects of the present disclosure are not limited to the technical effects described above, and other technical effects not mentioned herein may be understood to those skilled in the art to which the present disclosure belongs from the description below.

### DESCRIPTION OF DRAWINGS

The accompanying drawings, which are included to provide a further understanding of the present disclosure and constitute a part of the detailed description, illustrate embodiments of the present disclosure and serve to explain technical features of the present disclosure together with the description.

FIG. 1 is a schematic view illustrating an example of a wireless communication system using a Bluetooth low energy technology to which the present disclosure is applicable.

FIG. 2 illustrates an example of an internal block diagram of a device capable of implementing methods proposed by the present disclosure.

FIG. 3 illustrates an example of a Bluetooth communication architecture to which methods proposed by the present disclosure may be applied.

FIG. 4 illustrates an example of a structure of a generic attribute profile (GATT) of Bluetooth low energy.

FIG. 5 is a flowchart showing an example of a connection procedure method in Bluetooth low energy technology to which the present disclosure may be applied.

FIG. 6 is a flowchart illustrating an example of performing HID data transmission on LE ISO channel.

FIG. 7 illustrates an example of performing HID report transmission.

FIG. 8 illustrates another example of performing ULL data transmission on ISO channel.

FIG. 9 is a flowchart illustrating an example where a method of transmitting and receiving data in a short-range wireless communication system described in the present disclosure is performed by a first device.

FIG. 10 is a flowchart illustrating an example where a method of transmitting and receiving data in a short-range wireless communication system described in the present disclosure is performed by a second device.

### MODE FOR INVENTION

In order to help understanding of the present disclosure, the accompanying drawings which are included as a part of the Detailed Description provide embodiments of the present disclosure and describe the technical features of the present disclosure together with the Detailed Description. Like reference numerals principally designate like elements throughout the disclosure. Further, in describing the present disclosure, a detailed explanation of known related technologies may be omitted to avoid unnecessarily obscuring the subject matter of the present disclosure. Further, it is noted that the accompanying drawings are only for easily understanding the spirit of the present disclosure and it should not be interpreted that the spirit of the present disclosure is limited by the accompanying drawings.

Hereinafter, a method and an apparatus related with the present disclosure will be described in more detail with reference to drawings. In addition, a general term used in the present disclosure should be interpreted as defined in a dictionary or contextually, and should not be interpreted as an excessively reduced meaning. Further, a singular form used in the present disclosure may include a plural form if there is no clearly opposite meaning in the context. In the present application, a term such as “comprising” or “including” should not be interpreted as necessarily including all various components or various steps disclosed in the disclosure, and it should be interpreted that some component or some steps among them may not be included or additional components or steps may be further included. Suffixes “unit”, “module”, and “section” for components used in the following description are given or mixed in consideration of easy preparation of the disclosure only and do not have their own distinguished meanings or roles. The terms “first”, “second”, and the like are used to differentiate a certain component from other components, but the scope of should not be construed to be limited by the terms.

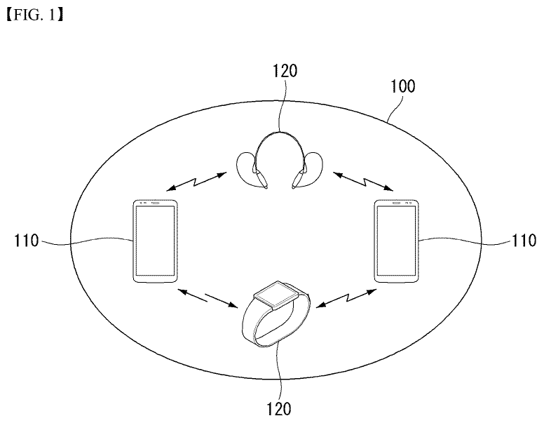

FIG. 1 is a schematic view illustrating an example of a wireless communication system using a Bluetooth low energy technology to which the present disclosure is applicable.

A wireless communication system 100 includes at least one server device 120 and at least one client device 110.

The server device and the client device perform Bluetooth communication using a Bluetooth low energy (BLE) technology.

First, compared with a Bluetooth basic rate/enhanced data rate (BR/EDR), the BLE technology has a relatively small duty cycle, may be produced at low cost, and significantly reduce power consumption through a low data rate, and thus, it may operate a year or longer when a coin cell battery is used.

Also, in the BLE technology, an inter-device connection procedure is simplified and a packet size is designed to be small compared with the Bluetooth BR/EDR technology.

In the BLE technology, (1) the number of RF channels is forty, (2) a data rate supports 1 Mbps, (3) topology has a scatternet structure, (4) latency is 3 ms, (5) a maximum current is 15 mA or lower, (6) output power is 10 mW (10 dBm) or less, and (7) the BLE technology is commonly used in applications such as a clock, sports, healthcare, sensors, device control, and the like.

The server device 120 may operate as a client device in a relationship with other device, and the client device may operate as a server device in a relationship with other device. That is, in the BLE communication system, any one device may operate as a server device or a client device, or may operate as both a server device and a client device if necessary.

The server device 120 may be expressed as a data service device, a slave device, a slave, a server, a conductor, a host device, a gateway, a sensing device, a monitoring device, a first device, a second device, etc.

The client device 110 may be expressed as a master device, a master, a client, a member, a sensor device, a sink device, a collector, a third device, a fourth device, etc.

The server device and the client device correspond to main components of the wireless communication system and the wireless communication system may include other components other than the server device and the client device.

The server device refers to a device that receives data from the client device, communicates directly with the client device, and provides data to the client device through a response when receiving a data request from the client device.

Further, the server device sends a notice/notification message and an indication message to the client device in order to provide data information to the client device. In addition, when the server device transmits the indication message to the client device, the server device receives a confirm message corresponding to the indication message from the client device.

Further, the server device may provide the data information to a user through a display unit or receive a request input from the user through a user input interface in the process of transmitting and receiving the notice, indication, and confirm messages to and from the client device.

In addition, the server device may read data from a memory unit or write new data in the corresponding memory unit in the process of transmitting and receiving the message to and from the client device.

Further, one server device may be connected to multiple client devices and may be easily reconnected to the client devices by using bonding information.

The client device 120 refers to a device that requests the data information or data transmission to the server device.

The client device receives the data from the server device through the notice message, the indication message, etc., and when receiving the indication message from the server device, the client device sends the confirm message in response to the indication message.

Similarly, the client device may also provide information to the user through the display unit or receive an input from the user through the user input interface in the process of transmitting and receiving the messages to and from the server device.

In addition, the client device may read data from the memory unit or write new data in the corresponding memory unit in the process of transmitting and receiving the message to and from the server device.

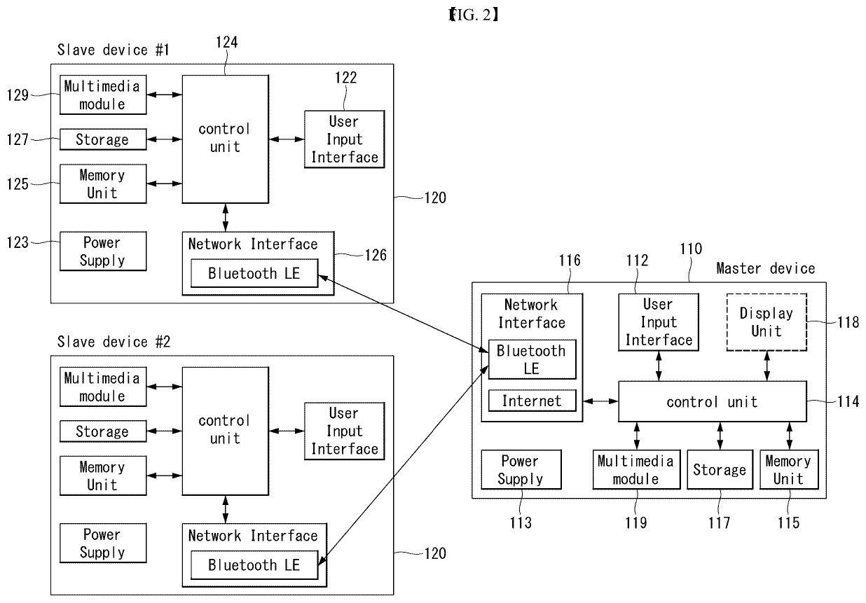

Hardware components such as the display unit, the user input interface, and the memory unit of the server device and the client device will be described in detail in FIG. 2.

Further, the wireless communication system may configure personal area networking (PAN) through Bluetooth technology. As an example, in the wireless communication system, a private piconet between the devices is established to rapidly and safely exchange files, documents, and the like.

FIG. 2 illustrates an example of an internal block diagram of a device capable of implementing methods proposed by the present disclosure.

As shown in FIG. 2, the master device 110 includes a user input interface 112, a power supply unit 113, a control unit 114, a memory unit 115), a network interface including a Bluetooth interface (Network Interface, 116), a storage (Storage, 117), an output unit (Display Unit, 118), and a multimedia module (Multi media Module, 119).

A network interface including the input unit (User Input Interface, 112), the power supply unit (Power Supply Unit, 113), the control unit (Control Unit, 114), the memory (Memory Unit, 115), and a Bluetooth interface (Bluetooth Interface) (Network Interface, 116), storage (Storage, 117), output unit (Display Unit, 118), and multimedia module (Multi media Module, 119) are functionally connected to each other to perform the method proposed in this specification.

In addition, as shown in FIG. 2, the slave devices (#1 and #2) 120 include an input unit (User Input Interface) 122, a power supply unit (Power Supply Unit) 123, a control unit (Control Unit, 124), memory (Memory Unit, 125), network interface (Network Interface, 126) including Bluetooth interface, storage (Storage, 127), output unit (Display Unit, 128), multi media module (Multi media Module, 129).

A network interface including the input unit (User Input Interface, 122), the power supply unit (Power Supply Unit, 123), the control unit (Control Unit, 124), the memory (Memory Unit, 125), and a Bluetooth interface (Bluetooth Interface) (Network Interface, 126), storage (Storage, 127), output unit (Display Unit, 128), and multimedia module (Multi media Module, 129) are functionally connected to each other to perform the method proposed in this specification.

The network interfaces 116 and 126 refer to units (or modules) capable of transmitting requests/responses, commands, notifications, instruction/confirmation messages, etc., or data between devices using Bluetooth technology.

The memories 115 and 125 are units implemented in various types of devices and refer to units in which various types of data are stored. Also, the storages 117 and 127 refer to units that perform a function similar to that of a memory.

The controllers 114 and 124 refer to a module that controls the overall operation of the master device 110 or the slave device 120, requests to transmit a message to a network interface, or controls to process a received message.

The controllers 114 and 124 may include an application-specific integrated circuit (ASIC), another chipset, a logic circuit, and/or a data processing device.

The memories 115 and 125 may include read-only memory (ROM), random access memory (RAM), flash memory, memory card, storage medium, and/or other storage devices.

The memories 115 and 125 may be inside or outside the processors 114 and 124, and may be connected to the processors 114 and 124 by various well-known means.

The output units 118 and 128 refer to modules for providing device status information and message exchange information to users through screens.

The power supply unit (power supply unit, 113, 123) refers to a module that receives external power and internal power under the control of the control unit and supplies power necessary for the operation of each component.

As discussed above, the BLE technology has a small duty cycle and can greatly reduce power consumption through a low data rate.

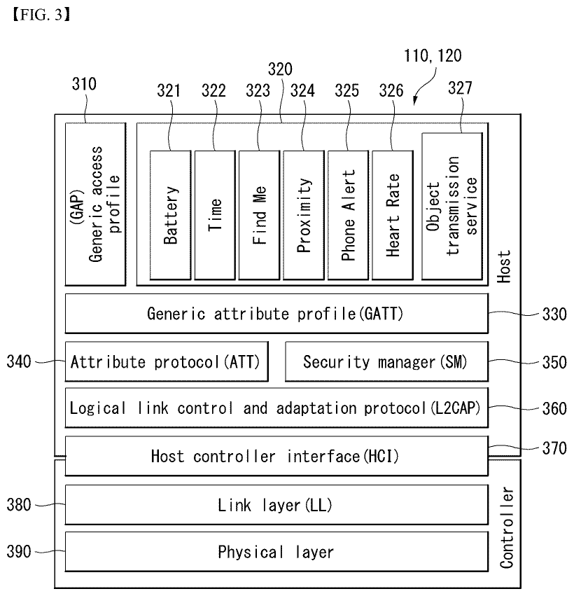

FIG. 3 illustrates an example of a Bluetooth communication architecture to which methods proposed by the present disclosure may be applied.

Specifically, FIG. 3 illustrates an example of an architecture of Bluetooth low energy (LE).

As shown in FIG. 3, the BLE structure includes a controller stack capable of processing a wireless device interface for which timing is critical and a host stack capable of processing high level data.

The controller stack may also be called a controller. In order to avoid confusion with the processor, that is, an internal element of the device described with reference to FIG. 2, however, the controller stack may be preferably used below.

First, the controller stack may be implemented using a communication module which may include a Bluetooth wireless device and a processor module which may include a processing device, such as a microprocessor.

The host stack may be implemented as part of an OS operating on the processor module or as a package instance on an OS.

In some cases, the controller stack and the host stack may operate or may be performed on the same processing device within the processor module.

The host stack includes a generic access profile (GAP) 310, GATT based profiles 320, a generic attribute profile (GATT) 330, an attribute protocol (ATT) 340, a security manager (SM) 350, and a logical link control and adaptation protocol (L2CAP) 360. The host stack is not limited to the aforementioned composition, but may include various protocols and profiles.

The host stack multiplexes various protocols and profiles provided by that Bluetooth disclosure using the L2CAP.

First, the L2CAP 360 provides one bilateral channel for sending data to according to a specific protocol or specific profile.

The L2CAP is capable of multiplexing data between upper layer protocols, segmenting or reassembling packages, and managing multicast data transmission.

BLE uses three fixed channels for respective signaling, a security manager, and an attribute protocol.

BR/EDR uses a dynamic channel and supports a protocol service multiplexer, retransmission, streaming mode.

The SM 350 authenticates a device, which is a protocol for providing a key distribution.

The ATT 340 relies on a server-client structure, which defines rules for a corresponding device for data access. Six message types are defined: Request, Response, Command, Notification, Indication, and Confirmation.
\textcircled{1} Request and Response message: the Request message is used when a client device requests specific information from a server device, and the Response message is used in response to a Request message, which is transmitted from the server device to the client device.
\textcircled{2} Command message: The Command message is transmitted from a client device to a server device in order to indicate a command for a specific operation, but the server device does not send a response to a Command message to the client device.
\textcircled{3} Notification message: A server device sends this message to a client device in order to provide notification of an event, but the client device does not send a confirmation message to the server device in response to a Notification message.
\textcircled{4} Indication and Confirm message: A server device sends this message to a client device in order to provide notification of an event. Unlike in the Notification message, the client device sends a Confirm message to the server device in response to an Indication message.

The generic access profile (GAP) is a layer newly implemented to support the BLE technology, and is used to control the selection of a role for communication between BLE devices and a multi-profile operation.

The GAP is mainly used for device discovery, connection establishment, and security. That is, the GAP defines a method for providing information to a user and also defines the following attribute types.
\textcircled{1} Service: A combination of actions related to data, and it defines the basic operation of a device.
\textcircled{2} Include: Define a relationship between services.
\textcircled{3} Characteristics: A data value used by a service
\textcircled{4} Behavior: A format that may be readable by a computer, which is defined by a Universal Unique Identifier (UUID) and a value type.

The GATT-based profiles are dependent on the GATT and are mainly applied to BLE devices. The GATT-based profiles may include Battery, Time, FindMe, Proximity, Object Delivery Service and so on. More specific descriptions of the GATT-based profiles are as follows.
Battery: A method for exchanging battery information.
Time: A method for exchanging time information.
FindMe: A method for providing an alarm service according to the distance.
Proximity: A method for exchanging battery information.
Time: A method for exchanging time information

The GATT may be used as a protocol by which to describe how the ATT is utilized at the time of composing services. For example, the GATT may be used to define how the ATT profiles are grouped together with services and to describe characteristics associated with the services.

Therefore, the GATT and the ATT describe device statuses and services, and how features are associated with each other and how they are used.

The controller stack includes a physical layer 390, a link layer 380, and a host controller interface 370.

The physical layer 390 (or a wireless transmission and reception module) sends and receives radio signals of 2.4 GHz, and uses GFSK modulation and frequency hopping utilizing 40 RF channels.

The link layer 380 sends or receives Bluetooth packets.

Furthermore, the link layer establishes a connection between devices after performing the advertising and scanning function using three advertising channels, and provides a function of exchanging a maximum of 42 bytes of data packets through 37 data channels.

The host controller interface (HCI) provides an interface between the host stack and the controller stack so that the host stack may provide commands and data to the controller stack and the controller stack may provide events and data to the host stack.

Hereinafter, the procedure of BLE is described briefly.

The BLE procedure includes a device filtering procedure, an advertising procedure, a scanning procedure, a discovering procedure, and a connecting procedure.

### Device Filtering Procedure

The device filtering procedure functions to reduce the number of devices which perform responses to requests, commands, or notification in the controller stack.

All of devices may not need to respond to received requests. Accordingly, the controller stack reduces the number of transmitted requests so that power consumption may be reduced in the BLE controller stack.

An advertising device or a scanning device may perform the device filtering procedure in order to restrict the number of devices which receive advertisement packets, scan requests, or connection requests.

In this case, the advertising device refers to a device which sends an advertisement event, that is, a device which performs advertisement, and is also called an advertiser.

A scanning device refers to a device which performs scanning, that is, a device which sends a scan request.

In the BLE disclosure, if a scanning device receives part of advertisement packets from an advertising device, the scanning device has to send a scan request to the advertising device.

If the transmission of a scan request is not required as the device filtering procedure is used, however, the scanning device may ignore advertisement packets transmitted by an advertising device.

The device filtering procedure may be used even in the connection request procedure. If device filtering is used for the connection request procedure, the need for sending a response to a connection request may be made unnecessary by ignoring the connection request.

### Advertising Procedure

An advertising device performs an advertisement procedure to perform non-directional broadcast using the devices within the range of the advertising device.

In this case, the non-directional broadcast refers to broadcast in all directions rather than broadcast in specific directions.

Unlike the non-directional broadcast, the directional broadcast refers to broadcast in a specific direction. Non-directional broadcast is performed without involving a connection procedure between devices in a listening state (hereinafter referred to as a “listening device”).

The advertising procedure is used to establish a BLE to a nearby initiating device.

In some embodiments, the advertising procedure may be used to provide the periodic broadcast of user data to scanning devices which perform listening through an advertising channel.

In the advertising procedure, all of advertisements (or advertisement events) are broadcasted through an advertising physical channel.

An advertising device may receive a scan request from a listening device which performs a listening operation in order to obtain additional user data from the advertising device. In response to the scan request, the advertising device sends a response to the listening device which has sent the scan request through the same advertising physical channel through which the advertising device has received the scan request.

While broadcast user data sent as part of advertising packets forms dynamic data, scan response data is static for the most part.

An advertising device may receive a connection request from an initiating device through an advertising (or broadcast) physical channel. If the advertising device has used a connectable advertisement event and the initiating device has not been filtered by a filtering procedure, the advertising device stops an advertisement and enters connected mode. The advertising device may resume the advertisement after entering the connected mode.

### Scanning Procedure

A device performing a scan operation, i.e., a scanning device, performs a scanning procedure in order to listen to the non-directional broadcast of user data from advertising devices which use an advertising physical channel.

In order to request additional user data, a scanning device sends a scan request to an advertising device through an advertising physical channel. In response to the scan request, the advertising device includes additional user data requested by the scanning device in a scan response and sends the scan response to the scanning device through the advertising physical channel.

The scanning procedure may be used while a scanning device is connected to another BLE device in a BLE piconet.

If a scanning device receives a broadcast advertising event and stays in initiator mode where a connection request may be initiated, the scanning device may initiate BLE for an advertising device by sending a connection request to the advertising device through an advertising physical channel.

If a scanning device sends a connection request to an advertising device, the scanning device stops the entire scanning for additional broadcast and enters connected mode.

### Discovering Procedure

Devices capable of Bluetooth communication (hereinafter referred to as “Bluetooth devices”) perform an advertising procedure and a scanning procedure in order to discover devices around the Bluetooth devices or devices to be discovered by other devices within a given area.

The discovering procedure is performed in an asymmetric manner. A Bluetooth device searching for another Bluetooth device nearby is called a discovering device, and performs listening in order to search for devices that advertise advertisement events that may be scanned. A Bluetooth device which may be discovered and used by another device is called a discoverable device. A discoverable device actively broadcasts an advertisement event so that other devices may scan the discoverable device through an advertising (or broadcast) physical channel.

Both the discovering device and the discoverable device may already have been connected to other Bluetooth devices in a piconet.

### Connecting Procedure

A connecting procedure is asymmetric. In the connecting procedure, while a particular Bluetooth device performs an advertising procedure, other Bluetooth devices need to perform a scanning procedure.

In other words, the advertising procedure may be a primary task to be performed, and as a result, only one device may respond to an advertisement. After receiving a connectable advertisement event from an advertising device, the connecting procedure may be initiated by sending a connection request to the advertising device through an advertising (or broadcast) physical channel.

Operation statuses defined in the BLE technology, that is, an advertising state, a scanning state, an initiating state, and a connection state, are described briefly below.

### Advertising State

The link layer (LL) enters the advertising state in a command from a host (or stack). If the link layer is in the advertising state, the link layer sends advertising packet data units (PDUs) at advertisement events.

Each advertisement event includes at least one advertising PDU, and the advertising PDU is transmitted through an advertising channel index. Each advertisement event may be previously closed if the advertising PDU is transmitted through each advertising channel index, the advertising PDU is terminated, or the advertising device needs to secure the space in order to perform other functions.

### Scanning State

The link layer enters the scanning state in response to a command from a host (or stack). In the scanning state, the link layer listens to advertising channel indices.

The scanning state supports two types: passive and active scanning. The host determines a scanning type.

No separate time or advertising channel index is defined to perform scanning.

In the scanning state, the link layer listens to an advertising channel index for “scanWindow” duration. scanInterval is defined as the interval between the start points of two consecutive scan windows.

If there is no scheduling collision, the link layer has to perform listening in order to complete all of the scanIntervals of scanWindows as commanded by the host. In each scanWindow, the link layer has to scan other advertising channel indices. The link layer uses all of available advertising channel indices.

In the case of passive scanning, the link layer is unable to send any packet, but only receives packets.

In the case of active scanning, the link layer performs listening to the advertising device to rely on the advertising PDU type by which additional information related to the advertising PDUs and advertising device may be requested.

### Initiating State

The link layer enters the initiating state in response to a command from a host (or stack).

In the initiating state, the link layer performs listening to advertising channel indices.

In the initiating state, the link layer listens to an advertising channel index for “scanWindow” duration.

### Connection State

The link layer enters a connection state when the device performing the connection request, i.e., the initiating device transmits CONNECT_REQ PDU to the advertising device or when the advertising device receives CONNECT_REQ PDU from the initiating device.

After entering the connections state, it is considered that the connection is created. However, it need not be considered so that the connection is established at the time of entering the connections state. An only difference between a newly created connection and the previously established connection is a link layer connection supervision timeout value.

When two devices are connected to each other, two devices play difference roles.

A link layer serving as a master is referred to as the master and a link layer serving as a slave is referred to as the slave. The master controls a timing of a connection event and the connection event refers to a time at which the master and the slave are synchronized.

A packet defined in the Bluetooth interface will be briefly described below. BLE devices use packets defined below.

### Packet Format

The link layer has only one packet format used for both an advertising channel packet and a data channel packet.

Each packet is constituted by four fields, i.e., a preamble, an access address, a PDU, and a CRC.

When one packet is transmitted in an advertising physical channel, the PDU will become an advertising channel PDU and when one packet is transmitted in a data physical channel, the PDU will become a data channel PDU.

### Advertising Channel PDU

The advertising channel PDU includes a 16 bit header and a payload of various sizes.

The PDU type field of an advertising channel included in the header supports PDU types defined in Table 1 below.

TABLE 1

| PDU | | | Permitted PHYs | | |
|---|---|---|---|---|---|
| Type | PDU Name | Channel | LE 1M | LE 2M | LE Coded |
| 0000b | ADV_IND | Primary Advertising | ● | | |
| 0001b | ADV_DIRECT_IND | Primary Advertising | ● | | |
| 0010b | ADV_NONCONN_IND | Primary Advertising | ● | | |
| 0011b | SCAN_REQ | Primary Advertising | ● | | |
| | AUX_SCAN_REQ | Secondary Advertising | ● | ● | ● |
| 0100b | SCAN_RSP | Primary Advertising | ● | | |
| 0101b | CONNECT_IND | Primary Advertising | ● | | |
| | AUX_CONNECT_REQ | Secondary Advertising | ● | ● | ● |
| 0110b | ADV_SCAN_IND | Primary Advertising | ● | | |

### Advertising PDU

The following advertising channel PDU types are called advertising PDUs and are used for specific events.
ADV_IND: a connectable non-directional advertisement event
ADV_DIREC_IND: a connectable directional advertisement event
ADV_NONCONN_IND: a non-connectable non-directional advertisement event
ADV_SCAN_IND: a non-directional advertisement event that may be scanned

The PDUs are transmitted by the link layer in the advertising state and are received by the link layer in the scanning state or initiating state.

### Scanning PDUs

The advertising channel PDU type below is called a scanning PDU and is used in the status described below.
SCAN_REQ: transmitted by the link layer in the scanning state and received by the link layer in the advertising state.
SCAN_RSP: transmitted by the link layer in the advertising state and received by the link layer in the scanning state.

### Initiating PDUs

The advertising channel PDU type below is called an initiating PDU.
CONNECT_REQ: transmitted by the link layer in the initiating state and received by the link layer in the advertising state.

### Data Channel PDU

The data channel PDU may have a 16-bit header and various sizes of payloads and include a message integrity check (MIC) field.

The procedure, the state, the packet format, and the like in the BLE technology, which are described above, may be applied in order to perform methods proposed by the present disclosure.

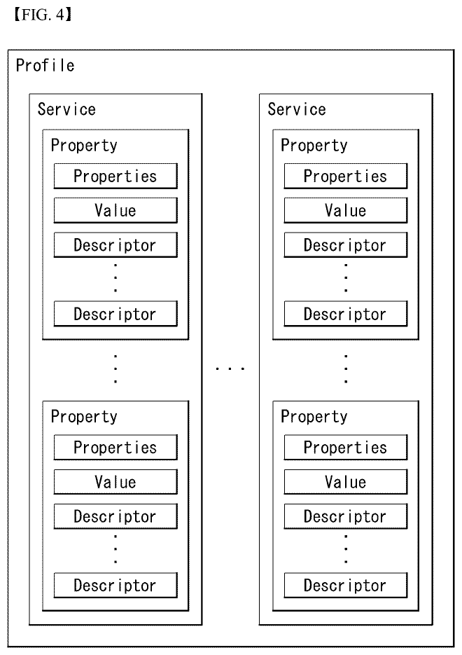

FIG. 4 illustrates an example of a structure of a generic attribute profile (GATT) of Bluetooth low energy.

Referring to FIG. 4, a structure for exchanging profile data of the Bluetooth low energy may be described.

Specifically, the generic attribute profile (GATT) is a definition of a method in which data is transmitted and received by using services and characteristics between the Bluetooth LE devices.

In general, a Peripheral device (e.g., a sensor device) serves as a GATT server and has a definition of services and characteristics.

A GATT client sends a data request to the GATT server in order to read or write the data and all transactions start at the GATT client and the response is received from the GATT server.

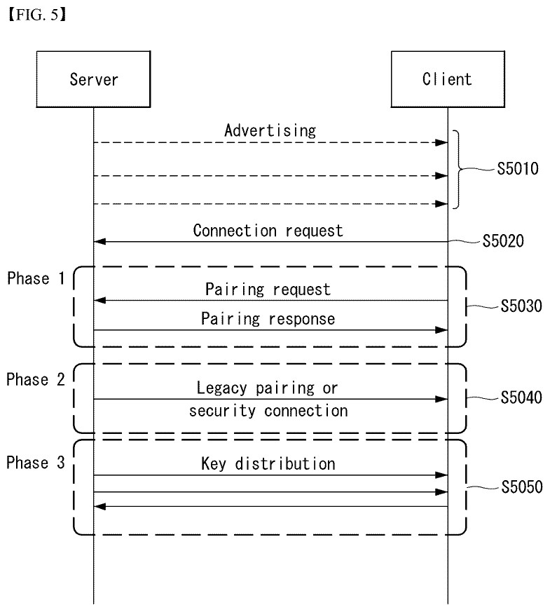

A GATT-based operation structure used in the Bluetooth LE may be based on THE profile, the service, and the characteristic, and may have a vertical structure illustrated in FIG. 5.

The profile may be constituted by one or more services and the service may be constituted by one or more characteristics or other services.

The service may serve to divide data into logical units and include one or more characteristics or other services. Each service has a 16-bit or 128-bit separator called a Universal Unique Identifier (UUID).

The characteristic is a lowest unit in the GATT-based operation structure. The characteristic includes only one datum and has a 16-bit or 128-bit UUID similar to the service.

The characteristic is defined as a value of various information and requires one attribute to contain each information. The characteristic may adopt various consecutive attributes.

The attribute is constituted by four components, which have the following meanings.
handle: Address of attribute
Type: Type of attribute
Value: Value of attribute
Permission: Access authority to attribute

FIG. 5 is a flowchart illustrating an example of a connection procedure method in Bluetooth low power energy technology to which the present disclosure may be applied.

A server transmits to a client an advertisement message through three advertising channels (S5010).

The server may be called an advertiser before connection and called as a master after the connection. As an example of the server, there may be a sensor (temperature sensor, etc.).

Further, the server may be called a scanner before the connection and called as a slave after the connection. As an example of the client, there may be a smartphone, etc.

As described above, in Bluetooth, communication is performed over a total of 40 channels through the 2.4 GHz band. Three channels among 40 channels as the advertising channels are used for exchanging sent and received for establishing the connection, which include various advertising packets.

The remaining 37 channels are used for data exchange after connection to the data channel.

The client may receive the advertisement message and thereafter, transmit the Scan Request message to the server in order to obtain additional data (e.g., a server device name, etc.).

In this case, the server transmits the Scan Response message including the additional data to the client in response to the Scan Request message.

Here, the Scan Request message and the Scan Response message are one type of advertising packet and the advertising packet may include only user data of 31 bytes or less.

Therefore, when there is data in which the size of the data is larger than 3 bytes, but overhead to transmit the data through the connection, the data is divided and sent twice by using the Scan Request message and the Scan Response message.

Next, the client transmits to the server a Connection Request message for establishing a Bluetooth connection with the server (S5020).

Therefore, a Link Layer (LL) connection is established between the server and the client.

Thereafter, the server and the client perform a security establishment procedure.

The security establishment procedure may be interpreted as security simple pairing or may be performed including the same.

That is, the security establishment procedure may be performed through Phase 1 through Phase 3.

Specifically, a pairing procedure (Phase 1) is performed between the server and the client (S5030).

In the pairing procedure, the client transmits a Pairing Request message to the server and the server transmits a Pairing Response message to the client.

Through the pairing procedure, authentication requirements and input (I)/output (O) capabilities and Key Size information are sent and received between the devices. Through the information, which key generation method is to be used in Phase 2 is determined.

Next, as Phase 2, legacy pairing or secure connections are performed between the server and the client (S5040).

In Phase 2, A 128-bit temporary key and a 128-bit short term key (STK) for performing the legacy pairing are generated.
Temporary Key: Key made for creating the STK
Short Term Key (LTK): Key value used for making encrypted connection between devices

When the secure connection is performed in Phase 2, a 128-bit long term key (LTK) is generated.
Long Term Key (LTK): Key value used even in later connection in addition to encrypted connection between the devices

Next, as Phase 3, a Key Distribution procedure is performed between the server and the client (S5050).

Therefore, the secure connection may be established and the data may be transmitted and received by establishing the encrypted link.

### General Matters Related to Isochronous Channel

With respect to an audio signal, audio streaming data or audio data may be periodically generated at an idle event interval.

The audio data is generated periodically (or at a specific time interval) according to a feature thereof. Here, the specific time interval at which the audio data is periodically generated may be expressed as idle event interval. Each audio data is transmitted at each idle event interval. Further, each audio data may be transmitted through an entire interval or a partial interval of the idle event interval. When the audio streaming data which is generated periodically or regularly is transmitted by using a BLE mechanism, an advertising and scanning procedure, a communication procedure, and a disconnection procedure should be performed whenever the generated audio data is transmitted/received. However, the audio data is generally periodically generated, and latency guarantee for audio data transmission is required regardless of a data mount of the audio data.

However, when the advertising and scanning procedure, the communication procedure, and the disconnection procedure should be performed each time newly generated audio data is transmitted, there is a problem in that latency occurs in audio data transmission.

In audio data transmission through hearing aids (HA) or headset, a data generation amount is comparatively small, so when BLE technology is utilized, higher energy efficiency may be obtained than Bluetooth BR/EDR technology, but since a data channel process of the BLE technology should perform advertising, connection, etc., every data transmission as described above, the data transmission has large overhead, and in particular, latency guarantee absolutely required for the audio data transmission may not be guaranteed.

Further, since the data channel process of the BLE technology has a purpose of transmitting isolatedly generated data only as necessary, and inducing deep sleep of a BLE device in other time domains to increase energy efficiency, it may be difficult to apply the data channel process of the BLE technology to transmission of periodically generated audio data.

### Definition of Isochronous Channel and Mechanism Related Thereto

A new channel, i.e., an isochronous channel is defined in order to transmit the periodically generated data by using the BLE technology.

The isochronous channel is a channel used for transmitting the isochronous data between devices (e.g., conductor-member) using an isochronous stream.

The isochronous data refers to data transmitted at a specific time interval, i.e., periodically or regularly.

That is, the isochronous channel may represent a channel in which periodically generated data such as audio data or voice data is transmitted and received in the BLE technology. Further, the isochronous channel may represent a channel on which data generated based on a user input of a game user's controller device is transmitted and received in a gaming scenario. The isochronous channel can be used for transmitting and receiving data to and from a single member, a set of one or more coordinated members, or multiple members. Further, the isochronous channel corresponds to a flushing channel which can be used for transmitting and receiving key data in an isochronous stream such as an audio streaming or other time domains.

The present disclosure proposes methods for enhancing an ultra-low latency (ULL) human interface device (HID). More specifically, there is an effect that a Bluetooth HID device can operate as fast as USB wired or dedicated wireless gaming HID devices and controllers for augmented, virtual or mixed reality (AR/VR/MR) scenarios through methods proposed in the present disclosure. In addition, there is an improvement effect in HOGP (HID Over GATT Profile) and human interface service (HIDS).

Basic architecture of ultra-low latency (ULL) using LE isochronous (ISO) channel is first described. The LE ISO channel may be used for ULL HID data transmission. In the basic architecture of the ULL using the LE ISO channel, most of the architecture (roles, procedures, services and operations) may be maintained in the same manner as LE GATT-based HOGP and HIDS. In this instance, in a setup stage, an ISO connection establishment procedure for ULL data transmission may be added to a control point procedure of HOGP. In the setup stage, a connection interval of asynchronous connection-less (ACL) channels may be set relatively short for the fast setup. In a data transfer stage after the setup stage, the connection interval of the ACL channels may be set long enough so that the ISO channel has a sufficient bandwidth. HID report data may be transmitted on the LE ISO channel after the setup.

FIG. 6 is a flowchart illustrating an example of performing HID data transmission on LE ISO channel.
S610: A procedure is performed to form a BLE connection between a HID host and a HID device. In this instance, the procedure for forming the BLE connection may include service discovery, characteristic discovery, and parameter negotiation.
S620: As a result of S610, the BLE connection between the HID host and the HID device is formed. Thereafter, a BLE isochronous (ISO) channel is formed between the HID host and the HID device through the formed BLE connection.
S630: Next, data transmission and reception between the HID host and the HID device is performed on the formed ISO channel.

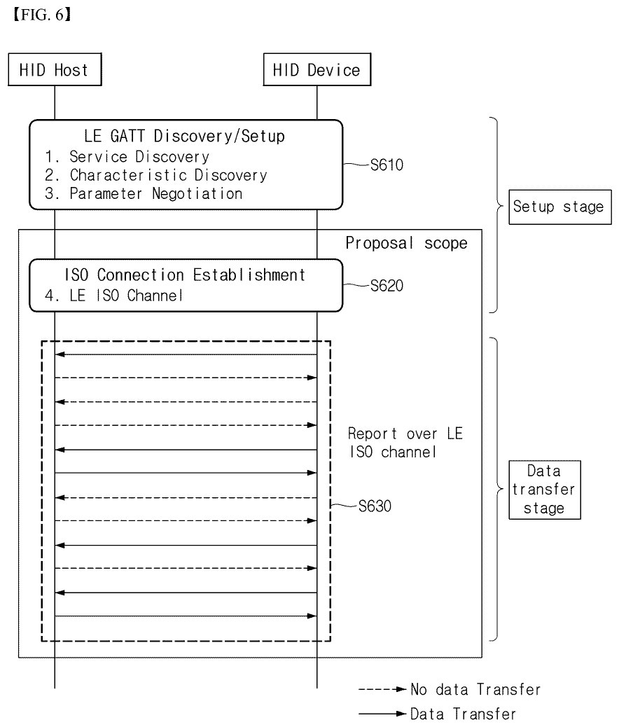

A method for improving a human interface device (HID) is described below with reference to FIG. 7.

FIG. 7 illustrates an example of performing HID report transmission. For HID improvement, SDU_Interval 730 of an application level data feed may be set to a relatively short interval of HID report 710, for example, 1 ms, 2 ms or 5 ms. In this instance, SDU_Interval may be selected by a HID host. The HID report 710 should be transmitted to a recipient as soon as possible after user input. For the ULL, there should be no buffering of data transmission and reception, and each time data is ready at a transmitting end, the data should be transmitted immediately. Each time data arrives at a receiving end, the received data should be immediately transmitted to the upper layer. In this instance, the SDU_Interval 730 should be evenly distributed within ISO_Interval 720 to give the same transmission occasion. When multiple input devices are connected to the host, connections of the input devices are all included in the same connected isochronous group (CIG). In this instance, each CIG may include each connected isochronous stream (CIS).

A method for improving HOGP (HID Over GATT Profile) and human interface service (HIDS) is described below.

For HOGP improvement, a function negotiation procedure to determine whether ULL is supported may be added. A control point procedure for ULL transmission configuration may also be added. In this instance, an input report (e.g., game controller input) is performed on the LE ISO channel. Further, an output report (e.g., game controller force feedback vibration, LED effect) is performed on the LE ISO channel. After configuring the LE ISO channel, a sufficient bandwidth may be provided to the LE ISO channel by increasing an ACL connection interval.

For HIDS improvement, an attribute for ULL function may be added to HID information characteristic, and a control point may be added to a command configuring the input report and/or the output report as ULL transmission.

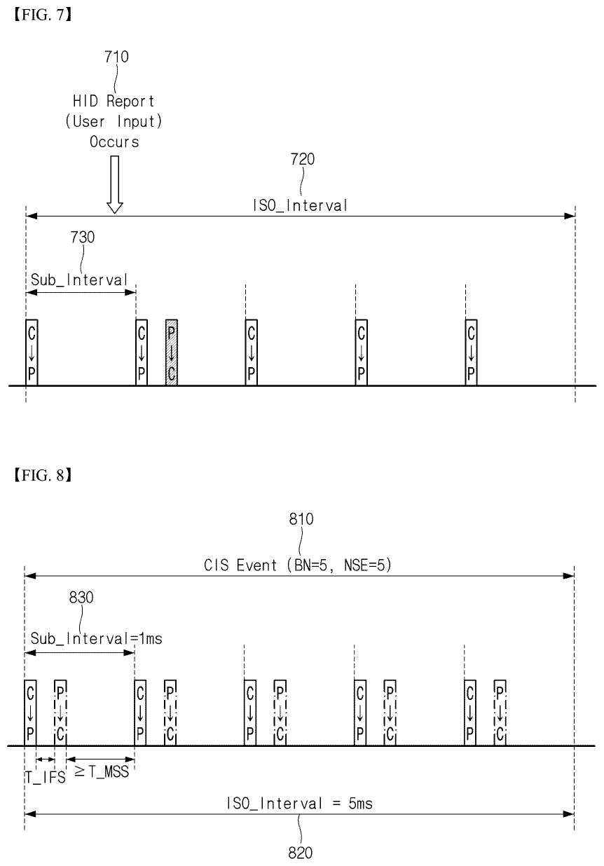

ULL data transmission on ISO channel is described below with reference to FIG. 8.

FIG. 8 illustrates another example of performing ULL data transmission on ISO channel. In FIG. 8, 1 ms-report interval 830 is the same as 1 ms-Sub_Interval of the LE ISO channel. In FIG. 8, for convenience of explanation, data traffic is assumed only from a peripheral device to a central device. The central device transmits a null packet to the peripheral device for polling. The null packet includes preamble (2 bytes)+access address (4 bytes)+header (2 bytes)+CRC (3 bytes) and has a length of 11 bytes. This may correspond to a packet time of 44 us in 2M PHY.

In FIG. 8, assuming HID data is mouse data (user input) whose size is 4 bytes long, a size of a HID report packet includes preamble (2 bytes)+access address (4 bytes)+header (2 bytes)+payload (4 bytes)+CRC (3 bytes)+MIC (4 bytes) and has a length of 19 bytes. This may correspond to a packet time of 76 us in 2M PHY.

If data is ready in the Sub_Interval 830, the HID report packet is transmitted. If data is not ready in the Sub_Interval 830, packet time is spent without data transmission. Minimum sub-event (SE)_length is 420 us, and both T_IFS and T_MSS have a time length of 150 us. Here, an ACL packet related to the ISO channel may be inserted into an empty space after T_MSS, and the ACL packet is required during the data transfer stage to maintain the ISO connection. The ACL packet required to maintain the ISO connection may be a very small null packet.

The following describes a data transmission method to ensure reliability when transmitting ULL data on the ISO channel.

It may be considered that the same input repetition operation at the user layer can hide a data loss at the link layer. If reliability is emphasized in an ULL mode, more retransmission occasions can be obtained by reducing the Sub_Interval, thereby increasing latency time.

In order to configure the retransmission occasions, in the example of FIG. 8 in which the Sub_Interval is set to 1 ms, if the Sub_Interval is reduced to 500 us, one retransmission occasion can be secured during the 1 ms-report interval. As above, if the Sub_Interval is reduced by ½, a timing diagram of central/peripheral pair events becomes only twice that of the example of FIG. 8. In the 1 ms-report interval, a second Sub_Interval may be used only for retransmission, and if a data transmission attempt in a first Sub_Interval is successful, the second Sub_Interval may end without data transmission. This method of configuring the retransmission occasions may affect all data traffics regardless of data type.

Unlike the method of configuring the retransmission occasions that affect all the data traffics regardless of the data type, retransmission occasions may be configured using an optional ACK mechanism at the application layer based on the data type. In this method, a balance between stability and latency time can be dynamically adjusted. More specifically, since data such as mouse/joystick movements and button presses are repetitive and very fast, it is important to process the data in real time rather than reliably. For this type of data, ACK may not be required. On the other hand, since text input data such as chatting during game play is one-time in nature and is very slow, stable data processing rather than real-time data processing is important. For this type of data, ACK may be required. An optional ACK mechanism as below may be used to configure the retransmission occasions in the above-described method.

First, always setting BN=NSE at the link layer means that data transmission is not retried at the link layer, where burst number (BN) represents the number of data packets transmitted in one ISO interval, and number of sub-events (NSE) represents the number of ISO sub-events included in one ISO interval. In addition, sequence number (SN) and next expected sequence number (NESN) may be ignored in a header field.

Next, if there are mouse/joystick movement data and button press data at the application layer, an ACK mechanism is not used.

In particular, ARQ (retransmission) and forward error correction (FEC) (i.e., repetition transmission) may be used for limited reliable transmission (LE-ISO). In this instance, in the FEC, up to three repetition transmissions may be preferably applied for ULL HID.

In the ARQ method, reliability of HID application layer can be guaranteed using characteristics of the link layer. In the ARQ method, ISO_Interval, BN, NSE, and FT (Flush timeout=1) parameters may be set to configure ISO_Interval. For example, if ISO Interval=10, BN=5, and NSE=10, one-time retransmission ARQ may be configured. Further, if ISO Interval=15, BN=5, and NSE=15, two-time retransmission ARQ may be configured.

In the FEC method, there is no retransmission in the link layer, the ISO_Interval parameter is set to always satisfy BN=NSE, and the same data is transmitted n times at the application layer. For example, if ISO Interval=10, BN=10, and NSE=10, the same data may be transmitted twice. Further, if ISO Interval=15, BN=15, and NSE=15, the same data may be transmitted three times.

In the method of configuring the retransmission occasion described in the present disclosure, each report may be given a unique report ID per report type (input, output, or function). Therefore, each report may be configured for a different processing based on its ID and type.

Each input and output report may be configured in one of the following two methods based on the report contents.

A report that requires stability with a higher priority than latency time is marked to be always transferred through HID-ACL transmission.

A report in which latency time has to be prioritized over reliability is marked to be transferred through HID-ISO transmission.

Required ACL packets for data transmission on the ISO channel are described below. 4 ACL control packets for the ISO channel are defined as below.
LL_CIS_REQ, LL_CIS_RSP, LL_CIS_IND, and LL_CIS_TERMINATE_IND: Obvious
LL_TERMINATE_IND: It is implied and can be used to control the ISO channel.
LL_POWER_CONTROL_REQ, LL_POWER_CONTROL_RSP, and LL_POWER_CHANGE_IND: It is implied and can be used to control the ISO channel.

The three packets related to the connection establishment are no longer needed in the data transfer stage. This is because the packets are not involved in the timing calculation in the data transfer stage.

Conversely, the data transfer stage requires termination and power control related packets. In this case, since the ACL is not the basic transmission, other control packets such as channel map, encryption or function are not needed. Therefore, it can be concluded that a required maximum size of ACL control payload is 5 which is very small. ACL packet time is short enough to be fixed in an empty space between ISO packets. If LL_CONNECTION_UPDATE_IND is used to wake-up/activate a sleep mode for the connection, it may be at least 12 bytes.

Parameters for configuration of Sub_Interval constituting the ISO Interval are described below. In the existing method, HCI command (HCI_LE_Set_CIG_Parameters) has no Sub_Interval parameter, and Sub_Interval is determined by other parameters such as Max_SDU Size. In this case, Sub_Interval in a wireless interface may vary depending on each implementation. Sub_Interval parameter may be included in the HCI command to obtain the same Sub_Interval in different implementations.

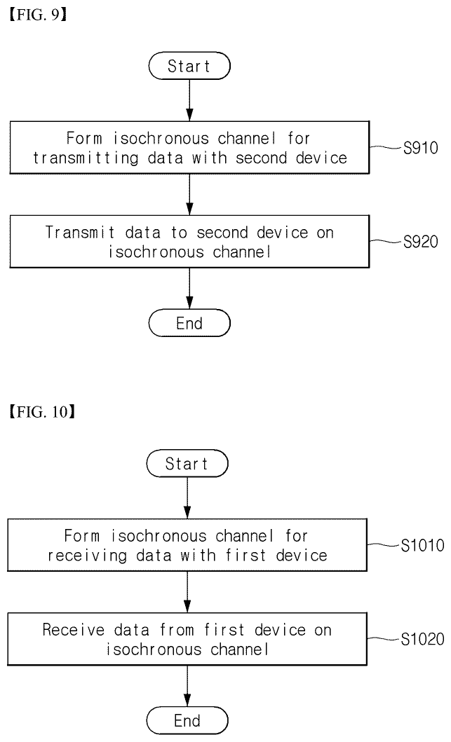

FIG. 9 is a flowchart illustrating an example where a method of transmitting and receiving data in a short-range wireless communication system described in the present disclosure is performed by a first device.

More specifically, the first device forms an isochronous channel for transmitting data with a second device, in S910.

Next, the first device transmits the data to the second device on the isochronous channel, in S920. In this instance, the data is human interface device (HID) data, and the channel for transmitting the data is determined based on data characteristics including reliability and urgency.

FIG. 10 is a flowchart illustrating an example where a method of transmitting and receiving data in a short-range wireless communication system described in the present disclosure is performed by a second device.

More specifically, the second device forms an isochronous channel for transmitting data with a first device, in S1010.

Next, the second device receives the data from the first device on the isochronous channel, in S1020. In this instance, the data is human interface device (HID) data, and the channel for transmitting the data is determined based on data characteristics including reliability and urgency.

It is obvious to those skilled in the art that the present disclosure can be embodied in other specific forms without departing from the essential features of the present disclosure. Accordingly, the above detailed description should not be construed as restrictive in all respects and should be considered illustrative. The scope of the present disclosure should be determined by reasonable interpretation of the appended claims, and all changes within the scope of equivalents in the present disclosure are included within the scope of the present disclosure.

The aforementioned embodiments are achieved by combination of structural elements and features of the present disclosure in a predetermined manner. Each of the structural elements or features should be considered selectively unless specified separately. Each of the structural elements or features may be carried out without being combined with other structural elements or features. Also, some structural elements and/or features may be combined with one another to constitute the embodiments of the present disclosure. The order of operations described in the embodiments of the present disclosure may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

An embodiment of the present disclosure may be implemented by various means, for example, hardware, firmware, software or a combination of them. In the case of implementations by hardware, an embodiment of the present disclosure may be implemented using one or more Application-Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers and/or microprocessors.

In the case of implementations by firmware or software, an embodiment of the present disclosure may be implemented in the form of a module, procedure, or function for performing the aforementioned functions or operations. Software code may be stored in the memory and driven by the processor. The memory may be placed inside or outside the processor, and may exchange data with the processor through a variety of known means.

It is obvious to those skilled in the art that the present disclosure can be embodied in other specific forms without departing from the essential features of the present disclosure. Accordingly, the above detailed description should not be construed as restrictive in all respects and should be considered illustrative. The scope of the present disclosure should be determined by reasonable interpretation of the appended claims, and all changes within the scope of equivalents in the present disclosure are included within the scope of the present disclosure.

### INDUSTRIAL APPLICABILITY

The preferred embodiments of the present disclosure described above are disclosed for an exemplary purpose, and modifications, changes, substitutions, or additions of various other embodiments may be hereinafter made by those skilled in the art within the technical spirit and the technical scope of the present disclosure disclosed in the appended claims.

1. A method of transmitting, by a first device, data in a short-range wireless communication system, the method comprising:
forming an isochronous channel for transmitting the data with a second device; and
transmitting the data to the second device on the isochronous channel,
wherein the data is human interface device (HID) data, and
wherein the channel for transmitting the data is determined based on data characteristics including a reliability and an urgency.

2. The method of claim 1, further comprising:
forming an asynchronous connection-less (ACL) channel for transmitting the data with the second device.

3. The method of claim 2, further comprising:
based on the data being a type of data where the reliability is prioritized regardless of the urgency, transmitting the data to the second device on the ACL channel.

4. The method of claim 1, wherein, based on the data being a type of data where the urgency is prioritized, the data is transmitted on the isochronous channel.

5. The method of claim 4, further comprising retransmitting the data,
wherein a number of times the data is retransmitted is set to a specific number or less.

6. The method of claim 5, wherein a time interval in which the data is retransmitted is set based on a channel configuration parameter for configuring the isochronous channel, and
wherein the channel configuration parameter includes a burst number (BN) representing a number of data packets within an isochronous interval that is a period in which the data transmission is performed, and a number of sub-events (NSE) representing a number of sub-intervals within the isochronous interval.

7. The method of claim 6, wherein the retransmission of the data is performed based on a method in which a value of the NSE is set to a multiple of a value of the BN.

8. The method of claim 7, wherein the retransmission of the data is performed as many times as the value of the NSE divided by the value of the BN.

9. The method of claim 8, wherein, based on an initial transmission of the data being successful, a retransmission in a sub-interval in which the data is retransmitted is not performed.

10. The method of claim 6, wherein the retransmission of the data is performed based on a method in which a value of the NSE and a value of the BN are set to the same value, and
wherein the retransmission of the data is performed regardless of whether an initial transmission of the data is successful or not.

11. A first device transmitting and receiving data in a short-range wireless communication system, the first device comprising:
a transmitter configured to transmit a radio signal;
a receiver configured to receive the radio signal;
at least one processor; and
at least one computer memory operably connectable to the at least one processor,
wherein the at least one computer memory is configured to store instructions performing operations based on being executed by the at least one processor,
wherein the operations comprise:
forming an isochronous channel for transmitting the data with a second device; and
transmitting the data to the second device on the isochronous channel,
wherein the data is human interface device (HID) data, and
wherein the channel for transmitting the data is determined based on data characteristics including a reliability and an urgency.

12. A method of receiving, by a second device, data in a short-range wireless communication system, the method comprising:
forming an isochronous channel for transmitting the data with a first device, and
receiving the data from the first device on the isochronous channel,
wherein the data is human interface device (HID) data, and
wherein the channel for transmitting the data is determined based on data characteristics including a reliability and an urgency.

13. (canceled)
